(19) United States
(12) Patent Application Publication
(10) Pub. No.: US 2005/0012681 A1
(43) Pub. Date: Jan. 20, 2005

(54) Three-dimensional image display device

(75) Inventor: Tae Soo Park, Seoul (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Electronics, Inc.

(21) Appl. No.: 10/826,244

(22) Filed: Apr. 16, 2004

(30) Foreign Application Priority Data
Apr. 17, 2003 (KR) P10-2003-0024402

(51) Int. Cl. G09G 5/00

(52) U.S. Cl. 345/6

(57) ABSTRACT

A three-dimensional image display device for providing an optimum three-dimensional image is disclosed. The device includes a three-dimensional image display device includes a display panel displaying at least one parallax image, and a mask formed of transparent regions and convertible regions alternately aligned along a horizontal direction, and formed in front of the display panel.

### CROSS-REFERENCE TO RELATED APPLICATIONS

This application claims the benefit of Korean Application No. P2003-024402, filed on Apr. 17, 2003, which is hereby incorporated by reference as if fully set forth herein.

### BACKGROUND OF THE INVENTION

1. Field of the Invention

The present invention relates to a display device, and more particularly, to a three-dimensional display device. Although the present invention is suitable for a wide scope of applications, it is particularly suitable for providing an optimum image having a high resolution.

2. Discussion of the Related Art

A wide range of display devices displaying three-dimensional images are being used in order to represent the images more graphically and with more real live action. In order to allow a viewer to experience the three-dimension of the image, a different image should be seen through each of the eyes of the viewer. The viewed images, which are inputted to the brain of the user through each of the left and right eyes, are then combined in the brain, thereby being perceived as a three-dimensional image.

In order to fabricate a device displaying three-dimensional images, a device providing a different image to each of the left and right eyes of the viewer is required. Among devices, there is a polarization display device, which uses a pair of three-dimension (3D) glasses for dividing the image into a left-eye image and a right-eye image. However, the polarization display device is inconvenient in that the viewer must wear the 3D glasses when viewing the displayed image.

There is also a three-dimensional image display device in which a flat display device, such as a liquid crystal display device and a plasma display device, and a device dividing the image by the different angles viewed by the viewer are combined.

Depending upon the device dividing the displayed image by the different angles viewed by the viewer, a wide range of methods, such as a lenticular method using a lenticular lens sheet, a parallax barrier method using a slit array sheet, an integral photography method using a micro-lens array sheet, and a holography method using a disturbance effect, can be proposed herein. Each of the above-mentioned methods has its advantages.

More specifically, unlike other methods representing a three-dimensional image only with a horizontal parallax, the integral photography method and the holography method can represent parallax images of all directions including the horizontal parallax. Accordingly, the integral photography method and the holography method are widely known to represent three-dimensional images as accurately as seen in real space. However, such methods require a massive amount of data to be processed, the technology of which is currently not available. Therefore, the adequate technology using the integral photography method and the holography method is considered to be available further in the future.

Meanwhile, the three-dimensional image of the lenticular method using the lenticular lens is formed by periodically sampling and multiplexing a parallax image per each direction having at least two scenes. At this point, as many parallax images per direction as possible should be used in order to allow the viewer to view the image three-dimensionally. However, in a generally used two-dimensional flat display device for displaying images, the number of pixels used is predetermined and limited. Accordingly, when the number of images having a parallax per each direction becomes larger, the resolution of the three-dimensional image is reduced. Therefore, the number of images having a parallax per each direction should be decided based on the resolution (i.e., the number of pixels) of the flat display device.

In order to resolve such problems of the related art lenticular method, a three-dimensional image display device using a lenticular lens tilted at a predetermined angle is proposed herein. The tilted lenticular lens can reduce loss in horizontal resolution. However, since the parallax image for each direction is divided at a tilted angle, instead of being accurately divided along the horizontal direction, the device using the tilted lenticular lens is disadvantageous in that the viewer should tilt his or her head in order to be able to view the optimum three-dimensional image.

### SUMMARY OF THE INVENTION

Accordingly, the present invention is directed to a three-dimensional image display device that substantially obviates one or more problems due to limitations and disadvantages of the related art.

An object of the present invention is to provide a three-dimensional image display device providing an optimum three-dimensional image and simultaneously providing an image having a high resolution.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a three-dimensional image display device includes a display panel displaying at least one parallax image, and a mask formed of transparent regions and convertible regions alternately aligned along a horizontal direction, and formed in front of the display panel.

Herein, the mask is formed of a liquid crystal display panel, and more specifically, the liquid crystal display panel is formed of liquid crystal display segments forming the transparent regions and the convertible regions. However, the transparent regions of the mask are not aligned along a perpendicular direction. Herein, a left side of an upper transparent region is aligned with a right side of a lower transparent region adjacent thereto, and a right side of an upper transparent region is aligned with a left side of a lower transparent region adjacent thereto.

The three-dimensional image display device further includes a controller converting one of a portion and all of the convertible regions into transparent regions depending upon a number of parallax images. Herein, the controller converts all of the convertible regions into transparent regions, when the number of parallax images is 1 or 0, and the controller converts a portion of the convertible regions into transparent regions, when the number of parallax images is less than a predetermined number. In addition, the controller controls a distance between the display panel and the mask depending upon a distance between a viewer and the mask.

In another aspect of the present invention, a three-dimensional image display device includes a display panel simultaneously displaying a plurality of parallax images, a mask provided in front of the display panel, and selectively having a portion of the mask become transparent, and a controller determining transparent regions and opaque regions of the mask depending upon a number of the parallax images.

Herein, the controller increases a number of the transparent regions and a number of the opaque regions when the number of parallax images is small, and reduces the number of the transparent regions and the number of the opaque regions when the number of parallax images is large. And, the controller reduces a size of the opaque regions when the number of parallax images is small, and increases the size of the opaque regions when the number of parallax images is large.

Furthermore, the controller alternately aligns the transparent regions and the opaque regions within the mask along a horizontal direction, and does not align the transparent regions along a vertical direction. Also, the controller detects a portion of the parallax images having no parallax, and the controller determines a portion of the mask corresponding to the portion of the parallax images having no parallax to become transparent regions.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings;

FIG. 1 illustrates an outline of a three-dimensional display device according to the present invention;

FIG. 2 illustrates a block diagram of the three-dimensional display device according to the present invention;

FIG. 3 illustrates a mask according to the present invention;

FIGS. 4 and 5 illustrate process steps of a method for representing a three-dimensional image according to the present invention; and

FIG. 6 illustrates a flow chart of the method for representing the three-dimensional image according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

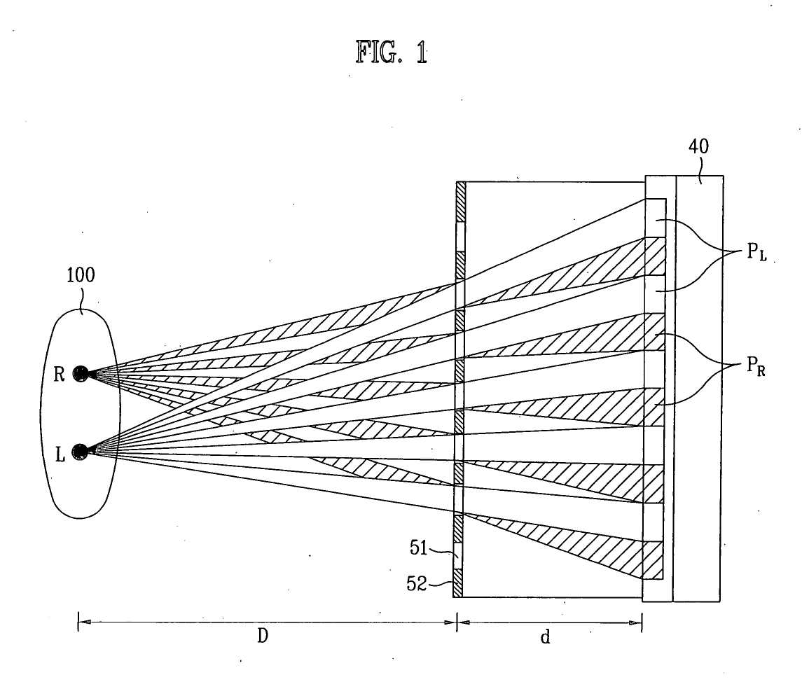

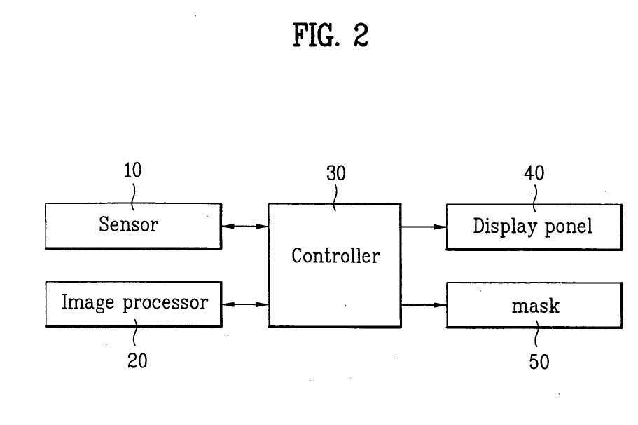

FIGS. 1 and 2 illustrate a three-dimensional image display device according to the present invention. Referring to FIG. 1, the three-dimensional image display device includes a mask 50 having transparent regions 51 and convertible regions 52 aligned to be spaced apart at a set distance, so as to provide a three-dimensional image to a viewer 100. The mask 50 is placed in front of a display panel 40 to be spaced apart at a set distance d. When the viewer 100 views the image, a right-side eye R and a left-side eye L of the viewer view perceive the image provided from the display panel 40 through the transparent regions 51 of the mask 50. At this point, pixels PR and PL of the display panel 40 display parallax images corresponding to the right-side eye R and the left-side eye L, respectively. The transparent regions 51 and the convertible regions 52 are alternately aligned along a horizontal direction, and the transparent regions 51 are aligned in a shifted form (i.e., a out-of-joint formation) along a vertical direction. The length and width Lt of the transparent regions 51 of the mask 50 are represented as

$$Lt = \frac{p ( D - d )}{D} .$$

Herein, p represents the length of a sub-pixel. More specifically, the size of the transparent region 51 should be equal to or smaller than 1/3 of the size of a pixel p. The size of the convertible region 52 of the mask varies according to the number of the parallax images. Therefore, the length Lc of the convertible region 52 of the mask 50 is represented as

$$Lc = \frac{( n - 1 ) p ( D - d )}{D} ,$$

and the width of the convertible region 52 is the same as that of the transparent region 51. Herein, n represents the number of the parallax images.

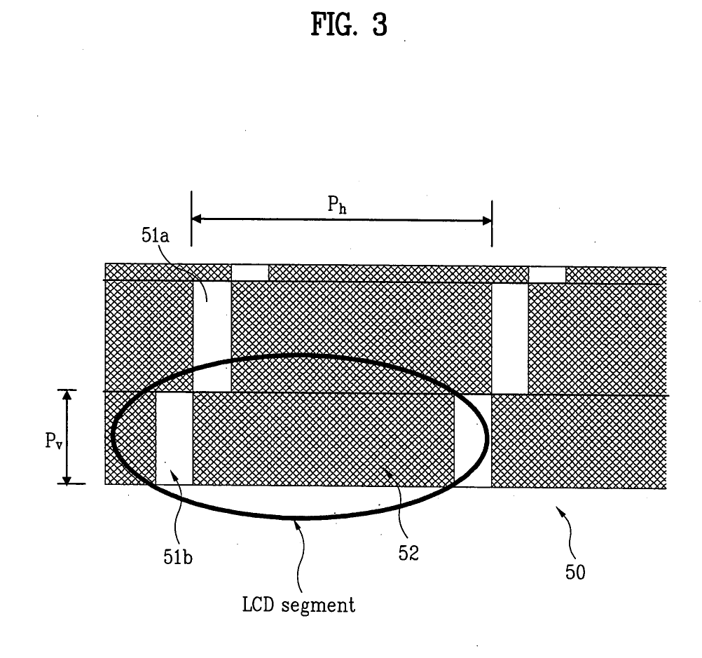

FIG. 3 illustrates an example of the mask 50 formed of liquid crystal display (LCD) segments including a transparent region 51 and a convertible region 52. In order to represent eight (8) parallax images, the size of the LCD segment should be equal to the size of (i.e., a total area) of eight (8) sub-pixels. More specifically, the length Ph and the width Pv of the LCD segment are represented as

$$Ph = \frac{8 p ( D - d )}{D} and Pv = \frac{p ( D - d )}{D} ,$$

respectively. The transparent regions 51 are aligned to be spaced apart at a set distance along the horizontal direction (i.e., along the row). In addition, upper transparent regions 51a and lower transparent regions 51b adjacent thereto are not aligned along the horizontal direction. In order to enhance the resolution of the image, the lower transparent region 51b adjacent to the upper transparent region 51a is placed on either the right side or the left side of the upper transparent regions, so as to form an out-of-joint formation. For example, either the left side of the upper transparent regions 51a is aligned with the right side of the lower transparent regions 51b adjacent thereto, or the right side of the upper transparent regions 51a is aligned with the left side of the lower transparent regions 51b adjacent thereto. It is apparent that the alignment formation of the upper and lower transparent regions 51a and 51b can vary in the present invention without departing from the spirit or scope of the inventions.

In another example of the mask 40, a liquid crystal display (LCD) panel, whereby a portion of the area becomes selectively transparent, can be used in the present invention. Depending upon the number of parallax images, the number and size of the transparent regions and the non-transparent regions (or opaque regions) are automatically decided.

Referring to FIG. 2, the present invention includes a sensor 10 for sensing the position of the viewer 100 and a distance D between the mask 50 and the viewer 100. When the sensor 10 senses the position of the viewer 100, a controller 30 controls the distance d between the display panel 40 and the mask 50 in accordance with the distance D between the mask 50 and the viewer 100.

The controller 30 also controls the transparent regions 51 and the convertible regions 52 of the mask 50. For example, when the mask 50 is an LCD panel, the controller 30 controls the liquid crystals of the transparent regions 51 and the convertible regions 52, so that light rays are selectively transmitted through the transparent regions 51 and the convertible regions 52. More specifically, the controller 30 may control the convertible regions 52 to maintain an opaque state, so as to allow the light rays to be transmitted only through the transparent regions 51. Conversely, the controller 20 may also control the convertible regions 52 to be transparent, so as to allow the light rays to be transmitted through both the transparent and convertible regions 51 and 52. In addition, the controller 30 may also control the number and size of the transparent and convertible regions 51 and 52 of the mask 50 depending upon the number of parallax images.

A method for representing a three-dimensional image by using the three-dimensional image display device according to the present invention will now be described in detail.

The parallax image provided to the three-dimensional image display device refers to an image produced by filming an image while moving the camera sideways (i.e., to the left and right sides) or rotating the object at short intervals.

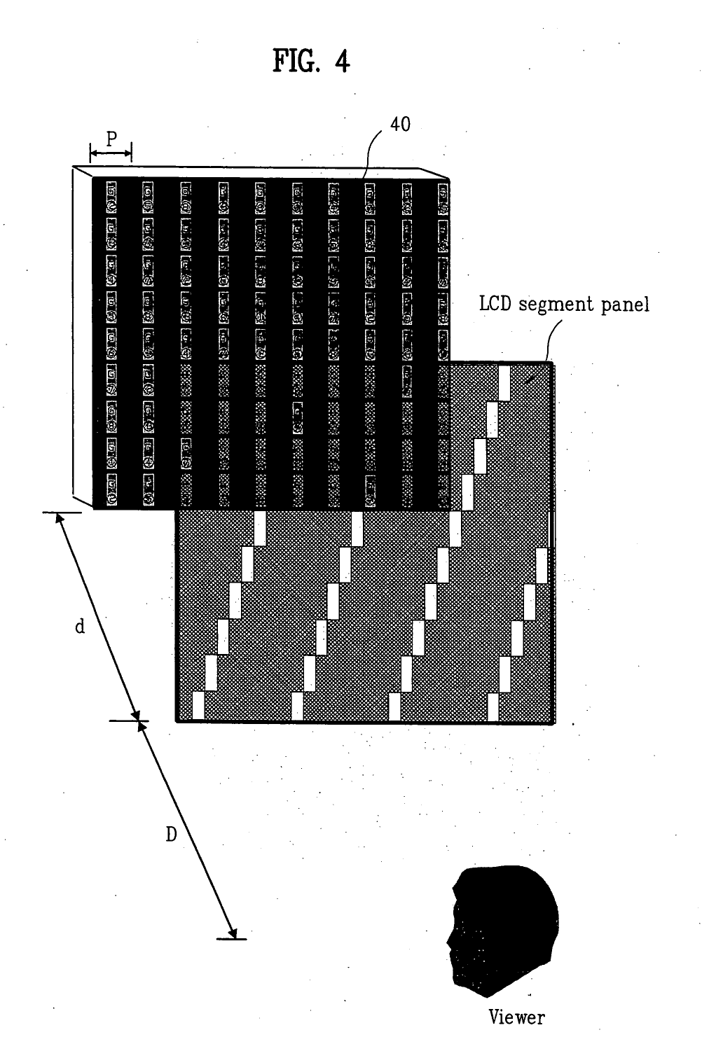

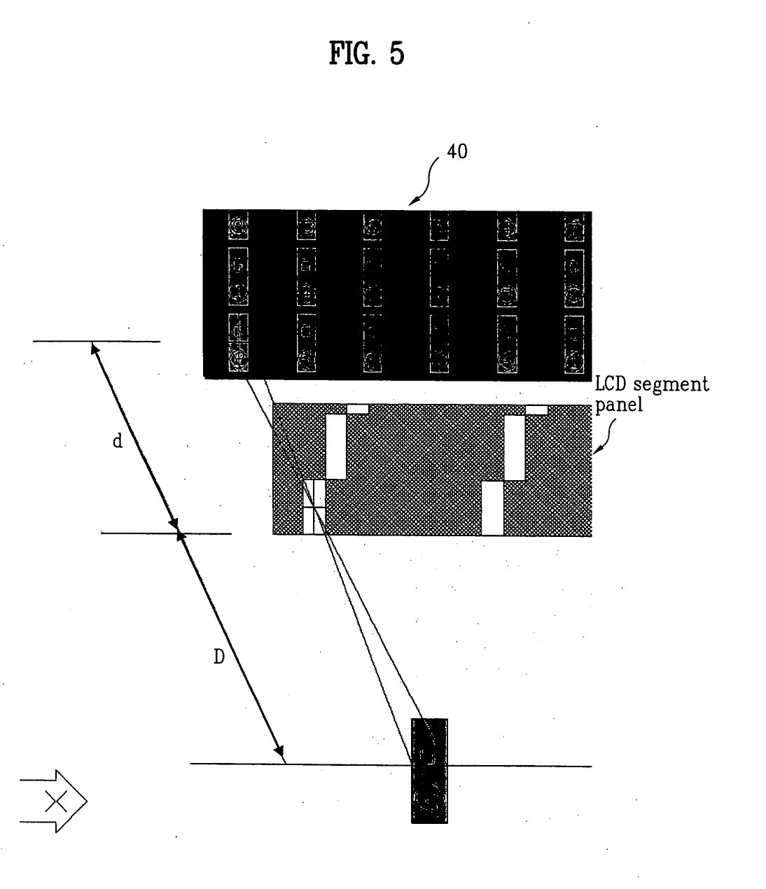

FIGS. 4 and 5 illustrates an example of pixels P displaying eight (8) parallax images. Each of the pixels is formed of red (R), green (G), and blue (B) sub-pixels. The number of parallax images can either be increased or reduced, in accordance with the principles of the present invention. When the number of parallax images increases, the viewer 100 is able to view and enjoy the displayed image at a wider range of viewing location and viewing angle. In other words, for example, the viewer 100 can move sideways along the same horizontal line as the mask 50 and still enjoy the same picture quality. However, in this case, the resolution of the displayed image is decreased, thereby deteriorating the picture quality. Therefore, the number of parallax images should be decided while taking into consideration the viewing angle of the viewer 100 and the resolution of the image.

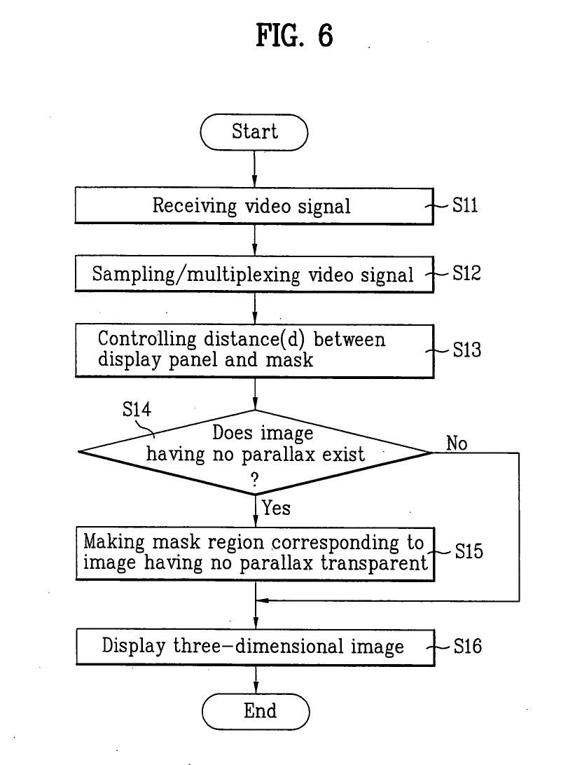

Referring to FIG. 6, when data of the parallax images including video signals are inputted to the three-dimensional display device (S11), an image processor 20 samples and multiplexes the video signals (S12). Then, the sampled and multiplexed video signals are converted into a displayable video data or a video frame.

The sensor 10 senses the location of the viewer 100, and the controller 30 controls the distance d between the display panel 40 and the mask 50 depending upon the location of the viewer 100 (S13). For example, as the distance D between the viewer 100 and the mask 50 becomes larger, the distance d between the display panel 40 and the mask 50 should also become larger. Conversely, as the distance D between the viewer 100 and the mask 50 becomes smaller, the distance d between the display panel 40 and the mask 50 should also become smaller.

Moreover, the controller 30 verifies the number of the parallax images and, then, either converts a portion of the transparent regions 51 into opaque regions, or converts a portion of the convertible regions 52 into transparent regions, depending upon the number of the parallax images. For example, when the number of parallax images is smaller than a predetermined number, the controller 30 converts a portion of the convertible regions 52 into transparent regions, thereby increasing the number of transparent regions allowing light to pass through and reducing the number of opaque regions. Conversely, when the number of parallax images is larger than the predetermined number, the controller 30 can also convert a portion of the transparent regions 51 into an opaque region, thereby reducing the number of transparent regions and increasing the number of opaque regions.

Also, the controller 30 compares the sampled and multiplexed image signals, so as to determine whether images having no parallax exist and to detect such images (S14). When at least two (2) signals having an identical portion is detected, the controller 30 determines that an image having no parallax exists and, then, converts a portion of the mask 50 corresponding to the pixel that is to display the image having no parallax into a transparent region (S15). In addition, when displaying a two-dimensional image having no parallax image included therein, all of the convertible regions 52 are converted into transparent regions, so as to prevent a resolution loss from occurring.

When the video frame is provided to the display panel 40, the images corresponding to each pixel of the display panel 40 are displayed (S16). Each eye of the viewer 100 perceives different parallax images, which are then combined into a three-dimensional image within the brain of the viewer.

The three-dimensional image display device according to the present invention has the following advantages.

The transparent regions are aligned in a shifted form (i.e., an out-of-joint formation), instead of being aligned perpendicularly, and a portion of the convertible regions of the mask can be converted into transparent regions, thereby providing the viewers with an image having a higher resolution.

Furthermore, the distance between the display panel and the mask can be controlled depending upon the location of the viewer, thereby providing an optimum three-dimensional image to the viewer.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A three-dimensional image display device, comprising:
a display panel displaying at least one parallax image; and
a mask formed of transparent regions and convertible regions alternately aligned along a horizontal direction, and formed in front of the display panel.

2. The device according to claim 1, wherein the mask is formed of a liquid crystal display panel.

3. The device according to claim 2, wherein the liquid crystal display panel is formed of liquid crystal display segments forming the transparent regions and the convertible regions.

4. The device according to claim 1, wherein the transparent regions of the mask are not aligned along a perpendicular direction.

5. The device according to claim 4, wherein a left side of an upper transparent region is aligned with a right side of a lower transparent region adjacent thereto.

6. The device according to claim 4, wherein a right side of an upper transparent region is aligned with a left side of a lower transparent region adjacent thereto.

7. The device according to claim 1, wherein a size of the transparent regions of the mask is equal to or less than ⅓ of a size of a pixel in the display panel.

8. The device according to claim 1, further comprising a controller converting a portion or all of the convertible regions into transparent regions depending upon a number of parallax images.

9. The device according to claim 8, wherein the controller converts all of the convertible regions into transparent regions, when the number of parallax images is 1 or 0.

10. The device according to claim 1, wherein the controller converts a portion of the convertible regions into transparent regions, when the number of parallax images is less than a predetermined number.

11. The device according to claim 1, wherein the controller controls a distance between the display panel and the mask depending upon a distance between a viewer and the mask.

12. A three-dimensional image display device, comprising:
a display panel simultaneously displaying a plurality of parallax images;
a mask provided in front of the display panel, and selectively having a portion of the mask become transparent; and
a controller determining transparent regions and opaque regions of the mask depending upon a number of the parallax images.

13. The device according to claim 12, wherein the controller controls a distance between the display panel and the mask depending upon a location of a viewer.

14. The device according to claim 12, wherein the controller increases a number of the transparent regions and a number of the opaque regions when the number of parallax images is small, and reduces the number of the transparent regions and the number of the opaque regions when the number of parallax images is large.

15. The device according to claim 12, wherein the controller reduces a size of the opaque regions when the number of parallax images is small, and increases the size of the opaque regions when the number of parallax images is large.

16. The device according to claim 12, wherein the controller determines the size of the opaque regions to be larger than that of the transparent regions.

17. The device according to claim 12, wherein the controller detects a portion of the parallax images having no parallax.

18. The device according to claim 12, wherein the controller determines a portion of the mask corresponding to the portion of the parallax images having no parallax to become transparent regions.

19. The device according to claim 12, wherein the controller alternately aligns the transparent regions and the opaque regions within the mask along a horizontal direction, and does not align the transparent regions along a vertical direction.
